(19) United States
(12) Patent Application Publication
(10) Pub. No.: US 2015/0084310 A1
(43) Pub. Date: Mar. 26, 2015

(54) UNIVERSAL FIFTH WHEEL PLATE COVER AND METHOD

(71) Applicant: Roger Dale Price, Vernon, AL (US)

(72) Inventor: Roger Dale Price, Vernon, AL (US)

(21) Appl. No.: 14/495,700

(22) Filed: Sep. 24, 2014

Related U.S. Application Data
(60) Provisional application No. 61/881,875, filed on Sep. 24, 2013.

(51) Int. Cl. B60D 1/01; B62D 65/00

(52) U.S. Cl. CPC B60D 1/015; B62D 65/00
USPC 280/433; 29/428

(57) ABSTRACT

An improved universal greaseless fifth wheel plate cover and method of installation are disclosed. The fifth wheel plate cover can be retrofitted to almost every existing conventional (greased) fifth wheel, or it could optionally be manufactured into new fifth wheels. The disclosed device comprises a slip plate, which preferably is comprised of a pair of mirror-imaged slip plate members, a plurality of tie down plates, and at least two ramp plate members. The slip plate(s) contain recessed pockets with a plurality of slip plate holes for receiving the plurality of tie down plates. Each tie down plate contains a plurality of corresponding tie down plate holes with sloped edges for contacting a fifth wheel top surface at a distance removed from the bottom edge of the slip plate, thereby ensuring that a weld to fixedly attach the tie down plate to the fifth wheel top surface does not compromise the integrity of the slip plate upon installation.

### CROSS-REFERENCES TO RELATED APPLICATIONS

This application claims the benefit of U.S. Provisional Application No. 61/881,875 by Roger Dale Price, filed Sep. 24, 2013, which is incorporated herein by reference in its entirety.

### FIELD OF THE INVENTION

The present invention is generally directed toward an improved greaseless fifth wheel plate cover and method of installation.

### BACKGROUND OF THE INVENTION

Fifth wheels are a coupling device for connecting a truck or semi-tractor to a trailer, which may be a van, a piggy-backed van, recreational vehicle, or other pulled vehicle. The bottom side of the trailer has a kingpin extending downward that mates with the bifurcated or horseshow-shaped fifth wheel located on the back of the truck. The fifth wheel locks the kingpin and, thus, the trailer for hauling. During operation, especially during turning, the truck and/or trailer may rotate around the axis of the kingpin locked in the fifth wheel. This rotation creates tremendous friction on the fifth wheel top plate and the plate on the trailer surrounding the kingpin. To facilitate the rotation and minimize wear of the fifth wheel and kingpin plates, conventional fifth wheels utilize grease. The fifth wheel grease may be lost during travel and when the trailer or truck rotates around the kingpin axis. Thus, fifth wheel grease must be applied during regular maintenance or as required. Furthermore, excessive rotation, such as large turns or during docking maneuvers, is known to force grease off the fifth wheel plate. Application of fifth wheel grease may cost the North American trucking industry up to US$20 billion per year. When fifth wheel grease is lost, it typically falls onto the truck, eventually ending up on the roadways, which creates a slick hazard for all motorists. If the fifth wheel is not properly greased or the grease comes off, such as during excessive rotation maneuvers, a “dry spot” could cause the trailer to become stuck in a position that is off center, which may cause excessive tire wear on truck and trailer alike, as well as safety issues for motorists.

Greaseless fifth wheel plate covers (also sometimes referred to as “lube plates”) have been designed in attempts to address these problems, such as U.S. Pat. No. 5,263,856 to Huehn et al. (the '856 patent, hereby incorporated herein by reference in its entirety) and U.S. Pat. No. 7,036,839 to Hungerlink et al. (the '839 patent, hereby incorporated herein by reference in its entirety). Lube plates have also been designed to be attached on the kingpin plate of a trailer. However, these products and designs have been flawed (see the '839 patent at cols. 1:25-2:22 and references cited therein, each hereby incorporated by reference) and have not been well received in the marketplace for these reasons. Other reasons have been thin, flimsy, and/or inadequate plate coverage design in the known greaseless fifth wheel plates. Another problem with these known greaseless fifth wheel plate covers has been that they have been designed to fit specific fifth wheels. Some designs can only be integrated into a specially manufactured fifth wheel, such as the FONTAINE® 7000CC SERIES® CLEAN-CONNECT® fifth wheel products. The known designs cannot be retrofitted onto all of the millions of fifth wheel bearing trucks on the road and the estimated one million new trucks that are placed on the road each year. A truly universal greaseless fifth wheel plate cover that overcomes the deficits of the existing products and can be utilized by nearly all existing and future conventional fifth wheels is lacking

### SUMMARY OF THE INVENTION

One aspect of the present invention is to eliminate the above difficulties and disadvantages by providing an improved universal greaseless fifth wheel plate cover. The universal greaseless fifth wheel plate cover comprising a slip plate, a plurality of tie down plates, and having at least two ramp plates. In some embodiments, the slip plate is comprised of a right hand slip plate and a left hand slip plate. The right hand and left hand slip plates each contain a plurality of recessed pockets, and the recessed pockets contain a plurality of slip plate holes. To facilitate attachment to the fifth wheel, the right hand and left hand slip plates each further contain a ramp plate receiving lip. The right hand and left hand slip plates each are made from one or more of a material having a low coefficient of friction selected from the group consisting of nylon, graphite, or an ultra-high molecular weight polyethylene material. To help prevent a trailer edge from catching on an edge of the slip plates, the right hand and left hand slip plates each have a chamfered outer edge and a chamfered edge on each of the recessed pockets. In further embodiments, the plurality of tie down plates comprise a bottom side facing a top surface of a fifth wheel, a top side facing away from the top surface of said fifth wheel, and a plurality of tie down plate holes. The plurality of tie down plate holes is configured to extend into a slip plate hole and contact the top surface of a fifth wheel. In still further embodiments, the contact edges of the plurality of tie down plate holes are at a sufficient distance away from a slip plate hole edge so that heat from a weld does not compromise the integrity of the slip plate. In yet further embodiments, the plurality of tie down plates are configured to hold the slip plate to the fifth wheel top surface when aligned within a plurality of recessed pockets of the slip plate and welded to the fifth wheel top surface.

Another aspect of the present invention is to provide an improved tie down plate for affixing a universal greaseless fifth wheel plate cover to a fifth wheel top surface, such that the device can be installed on new fifth wheels as they are manufactured or be retrofitted to almost any existing fifth wheel on the roadways. In some embodiments, the tie down plate comprises a bottom side facing said fifth wheel top surface, a top side facing away from said fifth wheel top surface, and a plurality of tie down plate holes. In further embodiments, the plurality of tie down plate holes is configured to extend into a slip plate hole and contact the fifth wheel top surface. In still further embodiments, the contact edge of the tie down plate holes is at a sufficient distance away from a slip plate hole edge so that heat from a weld does not compromise the integrity of the slip plate. In yet further embodiments, the tie down plate is configured to hold the slip plate to the fifth wheel top surface when aligned within a recessed pocket of the slip plate and welded to the fifth wheel top surface.

A still further aspect of the present invention is to provide an improved method of installing a universal greaseless fifth wheel plate cover, such that the device can be installed on new fifth wheels as they are manufactured or be retrofitted to almost any existing fifth wheel on the roadways. The method comprises the steps of placing a right hand slip plate and a left hand slip plate on a fifth wheel top surface; placing at least two ramp plates onto the fifth wheel top surface and ramp plate receiving lip of both right hand and left hand slip plates; placing a plurality of tie down plates within a plurality of recessed pockets within both right hand and left hand slip plates; and fixedly attaching said ramp plates and said tie down plates to said fifth wheel top surface. In some embodiments, the method further comprises the step of aligning the right hand and left hand slip plates on the fifth wheel top surface such that the right hand and left hand slip plates meet at an edge away from the ramp plate receiving lips. In further embodiments, the method further comprises the step of aligning a plurality of tie down plate holes on the plurality of tie down plates with a plurality of slip plate holes within the recessed pockets of both right hand and left hand slip plates. In still further embodiments, the step of fixedly attaching the ramp plates and the tie down plates to a fifth wheel top surface is accomplished by welding. In yet still further embodiments, the plurality of tie down plates are welded to a fifth wheel top surface along a plurality of welding edges of the plurality of tie down plate holes. In further embodiments, the plurality of tie down plate holes is significantly smaller than the plurality of slip plate holes. In still further embodiments, the welding of the ramp plates and the tie down plates to a fifth wheel top surface is alternated from welding points on the right hand slip plate and the left hand slip plate to prevent unintentional movement of the universal greaseless fifth wheel plate cover during installation.

### BRIEF DESCRIPTION OF THE DRAWINGS

Further advantages of the invention will become apparent by reference to the detailed description of preferred embodiments when considered in conjunction with the drawings:

FIG. 1 depicts a perspective view of an exemplary embodiment of the disclosed universal fifth wheel plate cover as installed on a fifth wheel.

FIG. 2A is an exploded view of an exemplary embodiment of the disclosed universal fifth wheel plate cover assembly.

FIG. 2B is a top elevation view of an exemplary embodiment of a right hand slip plate of the disclosed universal fifth wheel plate cover.

FIG. 3A is a top elevation view of an exemplary embodiment of a tie down plate of the disclosed universal fifth wheel plate cover.

FIG. 3B is a perspective view of an exemplary embodiment of a tie down plate of the disclosed universal fifth wheel plate cover.

FIG. 3C is a side elevation view of an exemplary embodiment of a tie down plate of the disclosed universal fifth wheel plate cover.

FIG. 4A is a top elevation view of an exemplary embodiment of a ramp plate of the disclosed universal fifth wheel plate cover.

FIG. 4B is a perspective view of an exemplary embodiment of a ramp plate of the disclosed universal fifth wheel plate cover.

FIG. 4C is a side elevation view of an exemplary embodiment of a ramp plate of the disclosed universal fifth wheel plate cover.

FIG. 5 is a cross-section view of a portion of an exemplary embodiment of the disclosed universal fifth wheel plate cover showing a left hand slip plate, recessed pocket, tie down plate, and fifth wheel surface.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

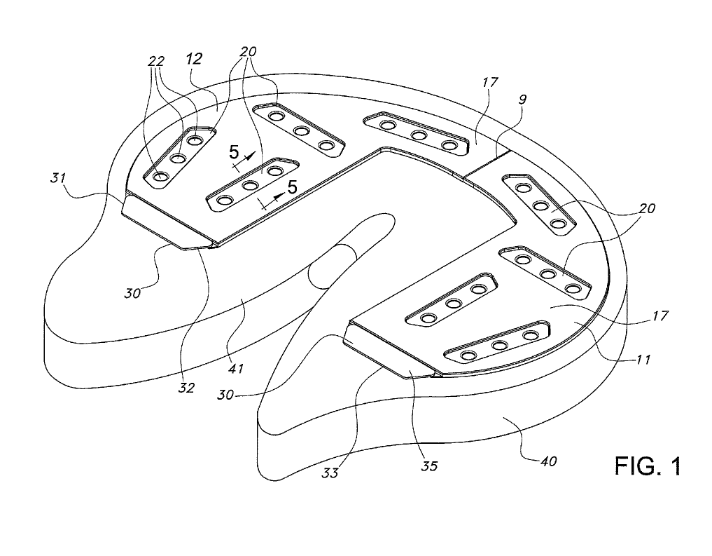

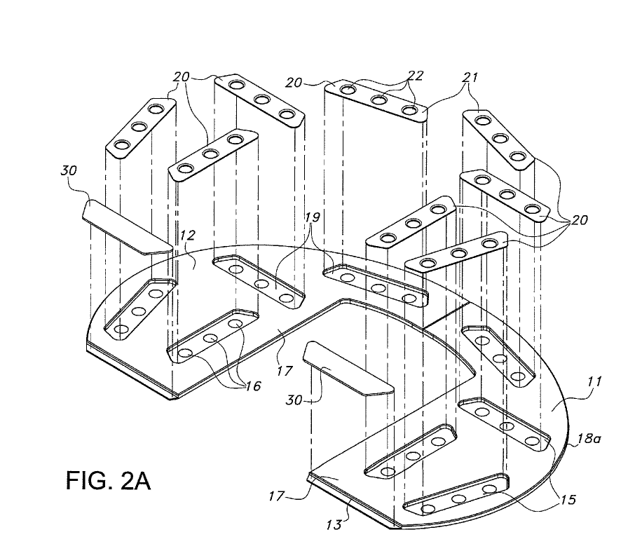

Referring now to the drawings, FIG. 1 illustrates an exemplary embodiment of the universal fifth wheel plate cover 10 configured for fixedly attaching to a fifth wheel 40 top surface 41. In one embodiment, the universal fifth wheel plate cover 10 comprises a one-piece slip plate (not shown), a plurality of tie down plates 20, and at least two ramp plates 30. In a preferred embodiment, the universal fifth wheel plate cover 10 comprises a multi-piece slip plate in the form of a the right hand slip plate 11 and a left hand slip plate 12, as shown in FIGS. 1 and 2. The right hand slip plate 11 and the left hand slip plate 12 are designed to cover a majority of the fifth wheel 40 top surface 41 area. Preferably, the right hand slip plate 11 and the left hand slip plate 12 are designed to cover a substantial majority of the fifth wheel 40 top surface 41 area, such that slip plates 11, 12 meet at junction 9. By covering more of the fifth wheel 40 top surface 41 area, it is less likely that an edge of a trailer will catch an edge of the right hand slip plate 11 or the left hand slip plate 12 during hitching, unhitching, or hauling. The coverage design of the universal fifth wheel plate cover 10 also provides a large surface area for trailer contact and also for a large wear surface to prolong its useful life.

The right hand slip plate 11 and the left hand slip plate 12 are made of any suitable material having a low coefficient of friction. In preferred embodiments, the right hand slip plate 11 and the left hand slip plate 12 are made of nylon, graphite, or an ultra-high molecular weight polyethylene (UHMWPE) material. In more preferred embodiments, the right hand slip plate 11 and the left hand slip plate 12 are made of UHMWPE. The right hand slip plate 11 and the left hand slip plate 12 can be made using any suitable method known, for example only and not limiting, heat compression molding, transfer molding, or injection molding. In preferred embodiments, the right hand slip plate 11 and the left hand slip plate 12 are made by heat compression molding.

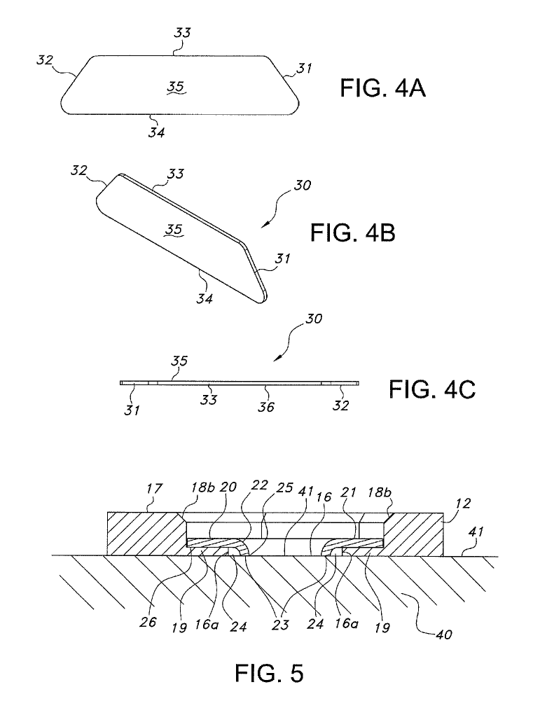

The plurality of tie down plates 20 are configured to fit into a plurality of recessed pockets 15 on the top surface (wear surface) 17 of right hand slip plate 11 and left hand slip plate 12, as can be appreciated in FIGS. 2A and 5. Each recessed pocket 15 contains a plurality of slip plate holes 16 created during manufacturing or machined following the chosen manufacturing process. The slip plate holes 16 are configured to align with the tie down plate holes 22, as can be appreciated in FIGS. 1, 2A, and 5. The recessed pockets 15 are preferably constructed to provide a sufficient dimensional depth of possible wear of right hand slip plate 11 and left hand slip plate 12 before a trailer could come into contact with the plurality of tie down plates 20. In a preferred embodiment, the dimensional depth of recessed pocket surface 19 and tie down plate 20 is 0.060 of an inch, while the total dimensional depth of right hand slip plate 11 and left hand slip plate 12 is 5/16ths of an inch, thus providing more than 0.19 of an inch of possible dimensional depth wear of the universal fifth wheel plate cover 10.

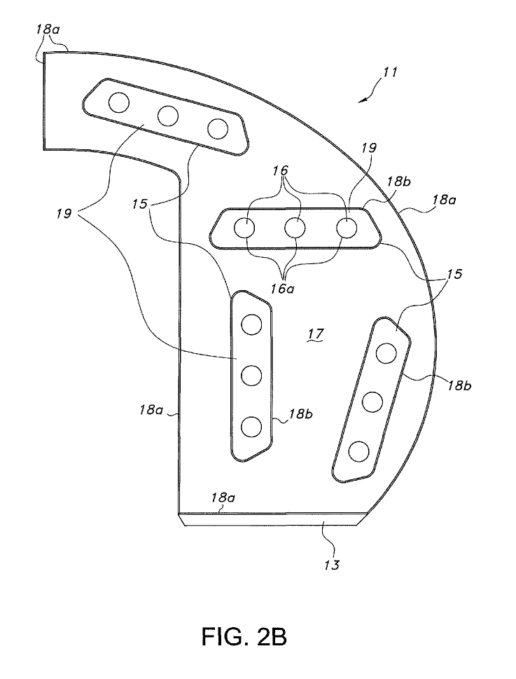

Referring to FIGS. 3A-3C, tie down plates 20 are designed to provide sufficient hold of the universal fifth wheel plate cover 10 to the top surface 41 of a fifth wheel 40 when fixedly attached thereto while simultaneously providing maximum slip plate wear surface 17 to slip plates 11, 12. In a preferred embodiment, tie down plates 20 are comprised of a four-sided stainless steel member having three extruded tie down plate holes 22, three fifth wheel contact surfaces 23, three welding edges 25, long sides 27, 28, short sides 29a, 29b, tie down plate top surface 21, and tie down plate bottom surface 26. Tie down plates 20 are placed inside recessed pockets 15 with tie down plate bottom surface 26 in contact with recessed pocket surface 19 and tie down plate top surface 21 facing toward slip plate wear surface 17. Other embodiments may be configured to have fewer or more extruded tie down plate holes 22, fifth wheel contact surfaces 23, and/or welding edges 25.

Tie down plates 20 can be made of any rigid material. In preferred embodiments, tie down plates 20 are made of metal capable of being fixedly attached to the top surface 41 of a fifth wheel 40 by welding. In more preferred embodiments, tie down plates 20 are made of stainless steel. Tie down plates 20 can be made by any known method in the art. In preferred embodiments, tie down plates 20 are made by stamping process. Tie down plate holes 22 are preferably made by punching and extrusion processes, but may be made by any suitable method known in the art. As can be seen in FIGS. 2A and 5, tie down plate holes 22 are significantly smaller than slip plate holes 16, which will discussed in more detail below.

In preferred embodiments, the universal fifth wheel plate cover 10 comprises eight recessed pockets 15 with eight corresponding tie down plates 20. Thus, right hand slip plate 11 and left hand slip plate 12 each contain four recessed pockets 15 with eight corresponding tie down plates 20, such as shown in FIGS. 1, 2A, and 2B. However, it should be readily understood that fewer or more would work sufficiently for fixedly attaching the universal fifth wheel plate cover 10 to the top surface 41 of a fifth wheel 40. As can be appreciated in FIG. 2B, the entire slip plate wear surface 17 preferably has a chamfered peripheral edge 18a. As best seen in FIG. 5, the recessed pocket edges 18b of slip plate wear surface 17 are also preferably chamfered. The chamfered edges 18a, 18b ensure that it is less likely that an edge of a trailer will catch one of the universal fifth wheel plate cover 10 edges 18a, 18b during hitching, unhitching, or hauling.

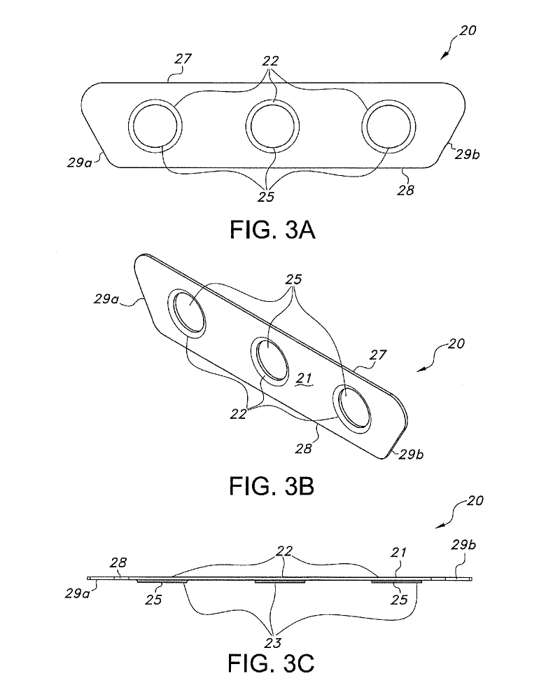

FIG. 4 illustrates an exemplary embodiment of a ramp plate 30 comprising short sides 31, 32; long sides 33, 34; ramp plate top surface 35; and ramp plate bottom surface 36. Ramp plates 30 can be made of any rigid material. In preferred embodiments, ramp plates 30 are made of metal capable of being fixedly attached to the top surface 41 of a fifth wheel 40 by welding. In more preferred embodiments, ramp plates 30 are made of stainless steel. Ramp plates 30 can be made by any known method in the art. In preferred embodiments, ramp plates 30 are made by stamping process. Ramp plates 30 are preferably constructed to have a dimensional depth that will prevent an edge of a trailer from catching one of the universal fifth wheel plate cover 10 edges below chamfered peripheral edge 18a, especially during hitching.

As shown in FIG. 2B, right hand slip plate 11 and left hand slip plate 12 (not shown) each comprise a ramp plate receiving lip 13 at the side closest to the bifurcated portion of a fifth wheel 40. In some embodiments, ramp plate receiving lip 13 is substantially flat (see FIG. 2B), while ramp plate receiving lip 13 may be gently sloped in other embodiments (see FIG. 2A). Ramp plates 30 serve at least two purposes for universal fifth wheel plate cover 10. First, ramp plates 30 provide a rigid and durable surface for a trailer edge to contact during the hitching process to guide the trailer on top of slip plate wear surface 17. Second, ramp plate 30 is fixedly attached to the top surface 41 of a fifth wheel 40 (preferably by welding along short sides 31, 32 and long side 33 to the top surface 41 of a fifth wheel 40; note that the weld(s) does not have to be continuous or comprise 100% of the available edges of sides 31-33), which provides support to hold the front edge of universal fifth wheel plate cover 10 to the fifth wheel 40 at the point most susceptible to mechanical failure by encountering a trailer edge during the hitching process.

Referring now to FIG. 1 in conjunction with FIG. 5, which is a cross-section through an assembled universal fifth wheel plate cover 10 on a fifth wheel 40 as seen at LINE A-A in FIG. 1, a better understanding of the installation process can be conveyed. First, right hand slip plate 11 and left hand slip plate 12 are placed and aligned as desired on a fifth wheel 40 top surface 41 (preferably clean and dry), as illustrated in FIG. 1. Then, ramp plates 30 are applied to ramp plate receiving lip 13 of both right hand slip plate 11 and left hand slip plate 12. Then, a plurality of tie down plates 20 are placed within the recessed pockets of both right hand slip plate 11 and left hand slip plate 12. Next, ramp plates 30 and tie down plates 20 are fixedly attached to the top surface 41 of fifth wheel 40. In preferred embodiments, ramp plates 30 and tie down plates 20 are welded to the top surface 41 of fifth wheel 40. The sequence of welding is not important, but it may be advantageous to alternate welding ramp plates 30 and/or tie down plates 20 on the right hand slip plate 11 and the left hand slip plate 12 to prevent unintentional movement of the slip plates 11,12 during the installation process. Ramp plates 30 are welded to the top surface 41 of fifth wheel 40 along sides 31, 32, and 33. It should be understood that 100% of the available welding edge surface of ramp plate 30 does not have to be welded to ensure a proper hold of the ramp plates 30, the right hand slip plate 11, or the left hand slip plate 12. In preferred embodiments, welding is accomplished on between 40-100% of the available welding edge surface of the ramp plates 30. In more preferred embodiments, welding is accomplished on between 50-90% of the available welding edge surface of the ramp plates 30.

Tie down plates 20 are welded to the top surface 41 of fifth wheel 40 at tie down plate holes 22 along the welding edges 25. It should be understood that 100% of the available welding edge surface of the welding edges 25 does not have to be welded to ensure a proper hold of the tie down plates 20, the right hand slip plate 11, or the left hand slip plate 12. In preferred embodiments, welding is accomplished on between 40-100% of the available welding edge surface of the welding edges 25. In more preferred embodiments, welding is accomplished on between 40-60% of the available welding edge surface of the welding edges 25. As previously mentioned, tie down plate holes 22 are significantly smaller than slip plate holes 16. The smaller diameter for tie down plate holes 22 results in buffer space 24 between the outer edge 16a of slip plate holes 16 and fifth wheel contact surfaces 23. Applying a weld to welding edges 25 creates a significant amount of heat locally that could potentially damage, destroy, or otherwise compromise the integrity of a slip plates 11,12. It can be appreciated from FIG. 5 that buffer space 24 decreases the chance of compromising the integrity of a slip plates 11,12 during installation due to heat from welding at welding edges 25. To further decrease the chance of compromising the integrity of a slip plates 11,12 during installation, water or a wet rag can be used to cool each weld after it is made. Once ramp plates 30 and the plurality of tie down plates 20 have been welded to the top surface 41 of fifth wheel 40, installation of universal fifth wheel plate cover 10 is complete. It should be appreciated that installation of universal fifth wheel plate cover 10 by the welding method is designed to permit retrofitting of almost every known fifth wheel 40 on the roadways. No special tools, fasteners, seat plates, or drilling of fifth wheel 40 to be retrofitted is required for installation of the universal fifth wheel plate cover 10 disclosed herein.

The installed universal fifth wheel plate cover 10 is designed to be durable and to require minimum maintenance. As previously mentioned, the available dimensional depth of the wear surface 17 for vertical wear is more than 0.19 of an inch in preferred embodiments. Based on tests (discussed in the Examples, below), this dimension is anticipated to provide multiple years of wear without the need for replacement. Maintenance is simple; merely wash dirt and road grime from universal fifth wheel plate cover 10 from time to time when washing or servicing the vehicle on which it is installed. If the universal fifth wheel plate cover 10 has been used in an environment that could lead to sand being deposited on it, the universal fifth wheel plate cover 10 should be washed at the next convenient opportunity as sand could cause excessive wear on the slip plates 11,12.

### EXAMPLE 1

An embodiment of the universal fifth wheel plate cover 10 was installed for testing on a fifth wheel 40 previously installed onto a truck following the method described above. The universal fifth wheel plate cover 10 used comprised a right hand slip plate 11 and a left hand slip plate 12, each having three recessed pockets for receiving tie down plates 20 (a total of nine tie down plates 20 were used in this configuration) and each having a ramp plate receiving lip 13, and two ramp plates 30. The tie down plates 20 were welded to the top surface 41 of the fifth wheel 40 at welding edges 25 of the tie down plate holes 22. Approximately 50% of the welding edge 25 received welding. The ramp plates 30 were welded to the top surface 41 of the fifth wheel 40 at sides 31, 32, and 33. The right hand slip plate 11 and the left hand slip plate 12 were made of UHMWPE material.

The installed embodiment of the universal fifth wheel plate cover 10 did not comprise chamfered edges, and it was noticed that trailer edges sometimes would catch an edge of the right hand slip plate 11 and/or the left hand slip plate 12. These events never resulted in a failure of the universal fifth wheel plate cover 10 (pulling off the universal fifth wheel plate cover 10 from the fifth wheel 40). It was found that the top portion (the portion away from the ramp plates 30) of the universal fifth wheel plate cover 10 was subject to being pulled away more than the bottom edge being held down by the welded ramp plates. To add extra hold at the top portion of the universal fifth wheel plate cover 10, a small countersunk hole was made in the top portion of each the right hand slip plate 11 and/or the left hand slip plate 12 and two stainless steel washers were welded to the top surface 41 of the fifth wheel 40 along the edge of the top portion of both the right hand slip plate 11 and/or the left hand slip plate 12. It was found that adding chamfered edges 18a,18b and a fourth tie down plate 20 (and corresponding fourth recessed pocket to each slip plate 11,12) alleviated the stress applied to the top portion, as shown in FIG. 1.

The installed embodiment of the universal fifth wheel plate cover 10 was made with at least 0.19 of an inch of dimensional depth of the wear surface 17 for vertical wear. The installed embodiment has shown minimum wear on the wear surface 17 after testing that has continued for more than 36 months.

### EXAMPLE 2

A further embodiment of the universal fifth wheel plate cover 10 was installed for testing on a fifth wheel 40 previously installed onto a truck following the method described above. This universal fifth wheel plate cover 10 comprised a right hand slip plate 11 and a left hand slip plate 12, each having three recessed pockets for receiving tie down plates 20 (a total of nine tie down plates 20 were used in this configuration) and each having a ramp plate receiving lip 13, and two ramp plates 30.

The tie down plates 20 were welded to the top surface 41 of the fifth wheel 40 at welding edges 25 of the tie down plate holes 22. Approximately 50% of the welding edge 25 received welding. The ramp plates 30 were welded to the top surface 41 of the fifth wheel 40 at sides 31, 32, and 33. All edges of the right hand slip plate 11 and the left hand slip plate 12 were chamfered 18a,18b to prevent catching by a trailer edge. The right hand slip plate 11 and the left hand slip plate 12 were made of UHMWPE material. This installed embodiment of the universal fifth wheel plate cover 10 has shown no visible wear on the wear surface 17 after testing that has continued for more than four months.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

1. A universal fifth wheel plate cover comprising a slip plate, a plurality of tie down plates, and at least two ramp plates.

2. The universal fifth wheel plate cover of claim 1, wherein said slip plate is comprised of a right hand slip plate and a left hand slip plate.

3. The universal fifth wheel plate cover of claim 2, wherein said right hand slip plate and said left hand slip plate each contain a plurality of recessed pockets, said recessed pockets contain a plurality of slip plate holes.

4. The universal fifth wheel plate cover of claim 3, wherein said right hand slip plate and said left hand slip plate each further contain a ramp plate receiving lip.

5. The universal fifth wheel plate cover of claim 4, wherein said right hand slip plate and said left hand slip plate each are made from one or more of a material having a low coefficient of friction selected from the group consisting of nylon, graphite, or an ultra-high molecular weight polyethylene material.

6. The universal fifth wheel plate cover of claim 5, wherein said right hand slip plate and said left hand slip plate each have a chamfered outer edge and a chamfered edge on each of said recessed pockets.

7. The universal fifth wheel plate cover of claim 1, wherein said plurality of tie down plates comprise a bottom side facing a top surface of a fifth wheel, a top side facing away from said top surface of said fifth wheel, and a plurality of tie down plate holes.

8. The universal fifth wheel plate cover of claim 7, wherein said plurality of tie down plate holes are configured to extend into a slip plate hole and contact said top surface of said fifth wheel.

9. The universal fifth wheel plate cover of claim 8, wherein said plurality of tie down plate holes are configured to extend into a slip plate hole and contact said top surface of said fifth wheel at a sufficient distance away from a slip plate hole edge so that heat from a weld does not compromise the integrity of said slip plate.

10. The universal fifth wheel plate cover of claim 7, wherein said plurality of tie down plates are configured to hold said slip plate to said top surface of said fifth wheel when aligned within a plurality of recessed pockets of said slip plate and welded to said top surface of said fifth wheel.

11. The universal fifth wheel plate cover of claim 1, wherein said at least two ramp plates are configured to hold said slip plate to a surface of a fifth wheel by aligning over at least two ramp plate receiving lips on said slip plate when welded to said surface of said fifth wheel.

12. A tie down plate for fixedly attaching a fifth wheel plate cover to a fifth wheel top surface comprising a bottom side facing said fifth wheel top surface, a top side facing away from said fifth wheel top surface, and a plurality of tie down plate holes.

13. The tie down plate of claim 12, wherein said plurality of tie down plate holes are configured to extend into a slip plate hole and contact said fifth wheel top surface.

14. The tie down plate of claim 13, wherein said plurality of tie down plate holes are configured to extend into a slip plate hole and contact said fifth wheel top surface at a sufficient distance away from a slip plate hole edge so that heat from a weld does not compromise the integrity of said slip plate.

15. The tie down plate of claim 14, wherein said tie down plate is configured to hold said slip plate to said fifth wheel top surface when aligned within a recessed pocket of said slip plate and welded to said fifth wheel top surface.

16. A method of installing a universal fifth wheel plate cover, said method comprising the steps of:
placing a right hand slip plate and a left hand slip plate on a fifth wheel top surface;
placing at least two ramp plates onto said fifth wheel top surface and ramp plate receiving lip of both right hand slip plate and left hand slip plate;
placing a plurality of tie down plates within a plurality of recessed pockets within both right hand slip plate and left hand slip plate; and
fixedly attaching said ramp plates and said tie down plates to said fifth wheel top surface.

17. The method of claim 16 further comprising the step of aligning said right hand slip plate and said left hand slip plate on said fifth wheel top surface such that said right hand slip plate and said left hand slip plate meet at an edge away from said ramp plate receiving lips.

18. The method of claim 16 further comprising the step of aligning a plurality of tie down plate holes on said plurality of tie down plates with a plurality of slip plate holes within said recessed pockets of both right hand slip plate and left hand slip plate.

19. The method of claim 18, wherein said step of fixedly attaching said ramp plates and said tie down plates to said fifth wheel top surface is accomplished by welding.

20. The method of claim 19, wherein said plurality of tie down plates are welded to said fifth wheel top surface along a plurality of welding edges of said plurality of tie down plate holes.
